(19) United States
(12) Patent Application Publication
(10) Pub. No.: US 2024/0186575 A1
(43) Pub. Date: Jun. 6, 2024

(54) ADDITIVE FOR ELECTROLYTE OF LITHIUM-ION BATTERY AND ELECTROLYTE AND LITHIUM-ION SECONDARY BATTERY INCLUDING SAME

(71) Applicant: MURATA MANUFACTURING CO., LTD., Kyoto (JP)

(72) Inventors: Hao ZHANG, Shanghai (CN); Yingtao CHEN, Shanghai (CN); Cheng ZHU, Shanghai (CN)

(21) Appl. No.: 18/419,718

(22) Filed: Jan. 23, 2024

Related U.S. Application Data
(63) Continuation of application No. PCT/CN2022/108021, filed on Jul. 26, 2022.

(30) Foreign Application Priority Data
Jul. 30, 2021 (CN) 202110873561.2

(51) Int. Cl. H01M 10/0567; H01M 4/02; H01M 4/38; H01M 10/0525

(52) U.S. Cl. CPC H01M 10/0567; H01M 4/38; H01M 10/0525; H01M 2004/028; H01M 2300/0025

(57) ABSTRACT

An additive for an electrolyte of a lithium-ion battery and an electrolyte and a lithium-ion secondary battery including same are provided. The additive for an electrolyte of a lithium-ion battery has a structure of formula (1), wherein R₁, R₂, and R₃ are each independently a saturated or unsaturated hydrocarbon group, a cyano group, an amide group, a pyridyl group, a thienyl group, or an aryl group having a carbon atom number of 5-15 and being substituted by at least one fluorine atom

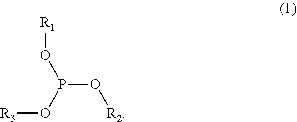

### CROSS REFERENCE TO RELATED APPLICATIONS

The present application is a continuation of PCT patent application no. PCT/CN2022/108021, filed on Jul. 26, 2022, which claims priority to Chinese patent application no. 202110873561.2, filed on Jul. 30, 2021, the entire contents of which are incorporated herein by reference.

### BACKGROUND

The present application relates to the field of lithium-ion secondary batteries, and in particular, to an additive for an electrolyte of a lithium-ion battery, an electrolyte and a lithium-ion secondary battery including same.

In recent years, along with the continuous updating of electronic technology, the requirements for battery devices for supporting the energy supply of electronic devices are increased. Nowadays, batteries capable of storing a high amount of electricity and outputting high power are needed. Traditional lead-acid batteries and nickel hydrogen batteries and the like may not meet the requirements of new electronic products. Therefore, lithium batteries have attracted more and more attention. During the development process of lithium batteries, the capacity and performance have been effectively improved.

In lithium-ion batteries, a ternary positive electrode material has a high specific capacity and thus has become a research hotspot. However, the ternary material has poor cycle performance at a high temperature and a high pressure, and is prone to a phase change especially under a high voltage, resulting in the precipitation of oxygen from the lattice, and causing a side reaction at an electrode interface. Currently, lithium-ion battery electrolytes widely used are mainly composed of a lithium salt and an electrolyte solvent. However, the described electrolytes still have many disadvantages, especially at a high voltage, the performance of lithium-ion batteries is poor, for example, the high-temperature cycle performance and the high-temperature storage performance are poor.

### SUMMARY

The present application relates to providing, in an embodiment, an additive for an electrolyte of a lithium-ion battery and an electrolyte and a lithium-ion secondary battery including same, so as to enhance the electrochemical performance of a lithium-ion battery, such as the cycle performance at a high temperature and a high pressure.

According to an aspect of the present application, provided is an additive for an electrolyte of a lithium-ion battery having a structure as represented by the following formula (1):

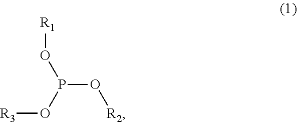

wherein R₁, R₂, and R₃ are each independently a saturated or unsaturated hydrocarbon group, a cyano group, an amide group, a pyridyl group, a thienyl group, or an aryl group having 5-15 carbon atoms and being substituted by at least one fluorine atom.

Further, in the additive, R₁, R₂, and R₃ are each independently an alkenyl group, an alkynyl group, a cyano group, a pyridyl group, or a thienyl group having 5-15 carbon atoms and be substituted with at least one fluorine atom.

Further, in the additive above, the additive is at least one selected from the following compounds:

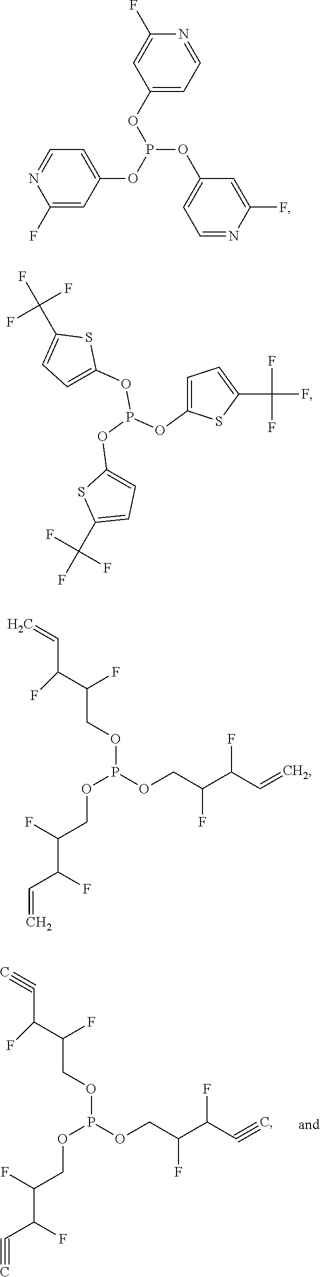

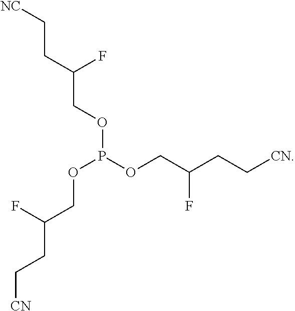 [SMILES: N#CCCC(F)COP(OCC(F)CCC#N)OCC(F)CCC#N]

According to another aspect of the present application, provided is an electrolyte for a lithium-ion battery, wherein the electrolyte comprises the additive in the foregoing aspects, the organic solvent, and the lithium salt.

Further, in the foregoing electrolyte, the amount of the additive is in a range of 0.5 parts by weight to 2 parts by weight based on 100 parts by weight of the organic solvent and the lithium salt.

Further, in the foregoing electrolyte, the organic solvent includes a cyclic carbonate, a linear carbonate, or any combination thereof.

Further, in the foregoing electrolyte, the organic solvent is selected from the group consisting of propylene carbonate, butylene carbonate, fluoroethylene carbonate, ethylene carbonate, diethyl carbonate, dipropyl carbonate, methylethyl carbonate, dimethyl carbonate, or combinations thereof.

Further, in the foregoing electrolyte, the lithium salt is selected from the group consisting of LiCl, LiBr, LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, Li₂SiF₆, or combinations thereof.

According to another aspect of the present application, provided is a lithium-ion secondary battery, including: a positive electrode sheet, a negative electrode sheet, a separator, and an electrolyte in the foregoing aspects of the present application.

Further, in the lithium-ion secondary battery above, the positive electrode active material of the positive electrode sheet is a high-nickel positive electrode material.

By means of using the additive for an electrolyte of a lithium-ion battery and the electrolyte and the lithium-ion secondary battery including same of the present application, the effect of improving the electrochemical performance of the lithium-ion battery, for example, the cycle performance at a high temperature and a high pressure, is achieved.

### DETAILED DESCRIPTION

It is important to note that the examples of the present application and the features in the examples can be combined in any suitable combination. Hereinafter, the present application will be described in further detail including with reference to examples.

As explained in the background portion, electrolytes for lithium-ion batteries in the prior art are mainly composed of a lithium salt and an electrolyte solvent. However, the described electrolytes still have many disadvantages, especially at a high voltage, the performance of lithium-ion batteries is poor, for example, the high-temperature cycle performance and the high-temperature storage performance are poor.

In electrolytes for lithium-ion batteries, phosphite additives, as effective positive electrode film-forming additives, have received wide attention. Such additives can inhibit LiPF₆ hydrolysis, remove HF, react with an active oxygen compound on the surface of the positive electrode, inhibit oxygen evolution, and improve the high-temperature and high-pressure performance of batteries. However, single-function electrolyte additives in the existing technology generally have limitations. In this regard, the present application, in an embodiment, relates to providing an electrolyte additive thatenhances battery performance, such as, improving the high temperature and high pressure battery performance.

According to an embodiment of the present application, provided is an additive for an electrolyte of a lithium-ion battery, having a structure as represented by the following formula (1):

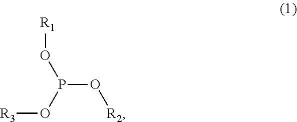

wherein R₁, R₂, and R₃ are each independently a saturated or unsaturated hydrocarbon group, a cyano group, an amide group, a pyridyl group, a thienyl group, or an aryl group having 5-15 carbon atoms and being substituted by at least one fluorine atom.

The fluorine atom has strong electron-withdrawing properties. When the additive is replaced by a fluorine atom, the electron cloud is dispersed, making it more difficult for the substance to lose electrons and thus has higher antioxidant capacity. Furthermore, after fluorine substitution, the oxidation resistance and chemical stability of the original carbonate and carboxylic ester materials can be increased, thereby further improving the high temperature performance of the battery, and being suitable for a lithium battery system with a higher voltage.

In addition, the wettability of the additive to the original solvent is increased after being substituted by a fluorine atom, so that the migration rate of lithium ions is increased, the impedance at the interface between the electrolyte and the electrode is reduced, and the low-temperature performance and the rate performance of the battery can be improved. In addition, the fluorine-substituted solvent has reduced flammability, and can improve the flame retardant effect and safety of the battery. Therefore, in the presentapplication, by fluorinating a phosphite additive, the oxidation resistance and thermal stability of the electrolyte are improved while the interface of the positive electrode is stabilized, thereby improving the high temperature performance of the battery.

The electrolyte system for a lithium-ion battery of the present application is obtained by adding the additive according to an embodiment to a conventional electrolyte. The addition of the additive effectively improves the high-temperature cycle performance and storage performance of the high-nickel positive electrode material of the lithium-ion battery, and suppresses oxygen evolution and reduces gas production, thereby reducing the volume growth in the battery cycle.

As represented by Formula (1), the additive of the present application includes a phosphite structure. The phosphite-containing additive can decompose on the surface of the electrode to form a stable passivation film, thereby preventing the electrolyte from being oxidatively decomposed on the surface of the positive electrode and inhibiting the dissolution of positive electrode metal ions at the same time. In addition, the phosphite can react with oxides such as O²⁻ and O₂²⁻ to form a stable phosphate compound, inhibit oxygen evolution, and reduce gas production, thereby improving the high-temperature performance of the battery.

While not wishing to be bound by theory, it is believed that the reaction mechanism of the phosphite additive of the present application combining with oxygen evolution on the surface of the positive electrode material in the battery is as follows:

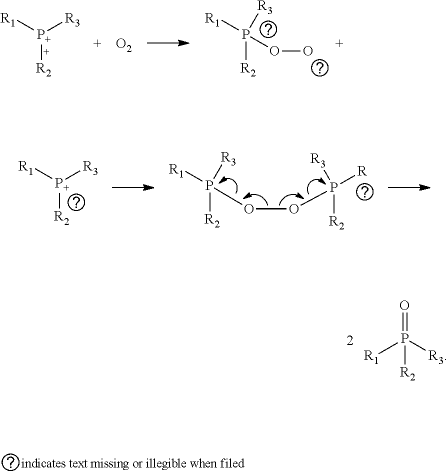

In an embodiment of the present application, the additive is at least one selected from the following compounds:

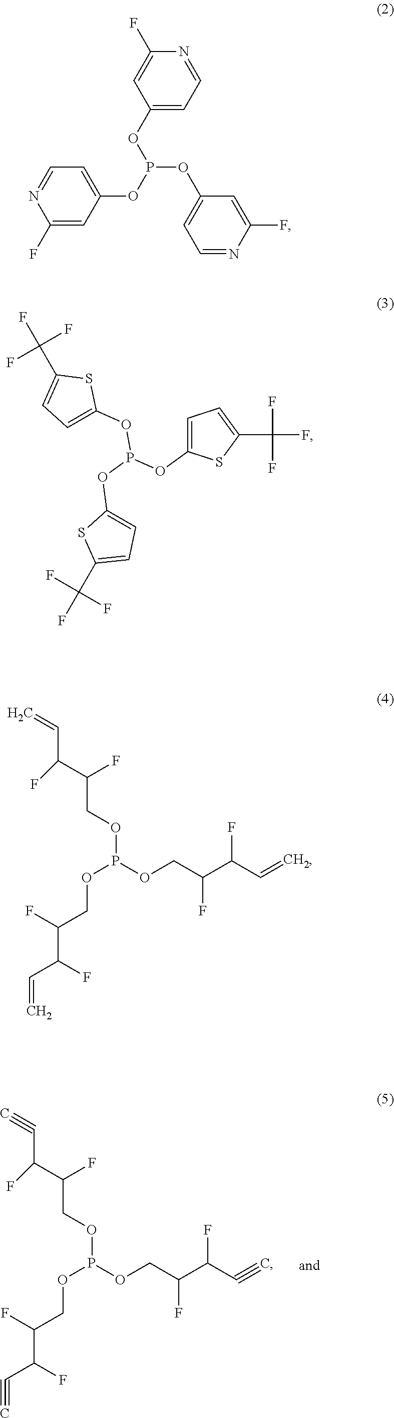

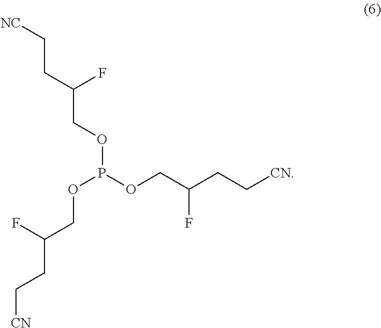 [SMILES: N#CCCC(F)COP(OCC(F)CCC#N)OCC(F)CCC#N]

In the compound of formula (2), R₁, R₂, and R₃ in formula (1) are each independently a fluoropyridine group, such as a 2-fluoro-4-pyridine group. By introducing a fluoropyridine group, transition metal ions in the electrolyte and hydrogen fluoride can be complexed, the dissolution of the transition metal ions and the deposition thereof at the negative electrode are inhibited, and the positive electrode and the negative electrode are further protected.

In the compound of formula (3), R₁, R₂, and R₃ in formula (1) are each independently a trifluoromethyl thienyl group, for example a 2-trifluoromethyl-5-thienyl group. The inventors found that by introducing a trifluoromethyl thienyl group, the thienyl group released after the decomposition of the additive may be polymerized on the electrode surface of the positive electrode to form a film in preference to the solvent, and the trifluoromethyl group can supplement LiF to the SEI film, thereby improving the high voltage cycle performance of the battery.

Accordingly, the described fluoropyridine group also has the same effect.

In addition, with regard to the compound of formula (3), the film formed on the surface of the positive electrode from the thienyl groups released after the decomposition of the additive has good conductivity, and therefore, an increase in battery impedance in cycles can be suppressed.

For the compounds of Formula (4) and Formula (5), R₁, R₂, and R₃ in Formula (1) are each independently a fluorine atom-substituted alkenyl and alkynyl group, such as 3,4-difluoro-1-penten-5-yl and 3,4-difluoro-1-pentyn-5-yl. As the additive has an unsaturated bond, the additive is prone to polymerize on the electrode surface of the positive electrode to form a film, and as the unsaturated bond are in an electron-deficient state, the additive is prone to obtain electrons on the surface of the negative electrode to form an SEI film.

For the compound of Formula (6), R₁, R₂, and R₃ in formula (1) are each independently a fluorine atom-substituted cyano group, such as 4-fluoro-1-pentylcyano-5-yl. The cyano group in the additive can complex the transition metal ions in the electrolyte, and can remove the acid in the electrolyte, thereby helping to improve the cycle retention rate of the battery.

In addition, when R₁, R₂, or R₃ in Formula (1) is an aryl group, when the battery is overcharged, the additive can be polymerized to form a film on the electrode surface, which increases the internal resistance of the battery and causes the battery to shut down, thus preventing the battery from overcharging. When R₁, R₂, or R₃ in formula (1) is an amide group, as the nitrogen element in the amide group has strong electronegativity and can be combined with lithium ions, the additive can improve the conductivity of the electrolyte and improve the rate performance of the battery.

According to another embodiment of the present application, provided is an electrolyte for a lithium-ion battery, including the additive in each of the described aspects of the present application, and an organic solvent and a lithium salt. The amount of the additive is in the range of 0.5 parts by weight to 2 parts by weight based on 100 parts by weight of the organic solvent and the lithium salt. As described in further detail in the following examples, when the amount of the additive is less than this range, the cycle retention rate of the battery and the volume growth rate of the battery are adversely affected; and when the amount of the additive is higher than this range, the cycle retention rate and the impedance after cycling of the battery are adversely affected, and at the same time, the costs of the electrolyte are increased. Particularly when the amount of the additive is out of the described range, there is an adverse effect on the high-temperature cycle performance of the battery.

According to a further embodiment of the present application, the organic solvent in the electrolyte for a lithium-ion battery includes a cyclic carbonate, a linear carbonate, or any combination thereof.

In an embodiment, the organic solvent is selected from the group consisting of propylene carbonate, butylene carbonate, fluoroethylene carbonate, ethylene carbonate, diethyl carbonate, dipropyl carbonate, methylethyl carbonate, dimethyl carbonate, or combinations thereof.

As describedherein, the additive of the present application can increase the oxidation resistance and chemical stability of the original carbonate substance, further improve the high temperature performance of the battery, and is suitable for a lithium battery system with a higher voltage. Furthermore, by adding the additive of the present application to an electrolyte containing a cyclic carbonate solvent, a linear carbonate solvent and a lithium salt, the high-temperature cycle and storage performance of a high-nickel positive electrode active material of a lithium-ion battery are effectively improved, oxygen evolution is suppressed, and gas production is reduced.

According to an embodiment, the lithium salt for the electrolyte of a lithium-ion battery of the present application is selected from the group consisting of LiCl, LiBr, LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, Li₂SiF₆, or combinations thereof. As described herein, the additive of the present application can suppress hydrolysis of LiPF₆, thereby improving high-temperature and high-pressure performance of the battery.

According to another embodiment of the present application, provided is a lithium-ion secondary battery, including: a positive electrode sheet, a negative electrode sheet, a separator, and the electrolyte in each of the foregoing aspects of the present application.

In an embodiment, the lithium-ion secondary battery of the present application is prepared as follows.

Preparation of a positive electrode sheet: A positive electrode active material, a conductive agent, a binder, and a dispersant are mixed to obtain a positive electrode mixture, and the mixture is dispersed in a solvent to obtain a positive electrode mixture slurry. Then, the positive electrode mixture slurry is coated onto the positive electrode current collector, dried, and molded by pressing to form a positive electrode sheet.

Preparation of a negative electrode sheet: A negative electrode active material, a conductive agent, a binder, and water are stirred to prepare a negative electrode slurry. The negative electrode slurry is then coated onto the negative electrode current collector, dried, and molded by pressing to form a negative electrode sheet.

Formulation of an electrolyte: The organic solvent, the lithium salt, and the additive described above are mixed to prepare an electrolyte.

Battery assembly: The positive electrode sheet prepared in the described step as a positive electrode, the negative electrode sheet prepared in the described step as a negative electrode, and an electrolyte, a separator and a battery housing are assembled into a battery.

In a preferred embodiment, the active material of the positive electrode sheet in the lithium-ion secondary battery of the present application is a high-nickel positive electrode active material. Examples of the high-nickel positive electrode active material include, but are not limited to, nickel cobalt lithium manganate (e.g., LiNi_{0.6}Co_{0.2}Mn_{0.2}O₂, or NCM622, or LiNi_{0.8}Co_{0.1}Mn_{0.1}O₂, or NCM811) and nickel cobalt lithium aluminate (NCA, e.g., LiNi_{0.8}Co_{0.15}Al_{0.05}O₂).

The electrolyte of the present application is particularly suitable for use in a lithium-ion battery having a high-nickel positive electrode. As described herein, the addition of the additive of the present application effectively improves the high temperature cycle performance and storage performance of the high-nickel positive electrode material of the lithium-ion battery.

The present application will be further described in detail in conjunction with the following examples, and these examples should not be construed as limiting the scope of protection of the present application.

### Comparative Example

A lithium-ion battery used in the Comparative Example was prepared by the following procedure.

Preparation of a positive electrode sheet: A positive electrode active material nickel cobalt lithium aluminate NCA (specifically, LiNi_{0.8}Co_{0.15}Al_{0.05}O₂) (95.5 parts by weight), conductive carbon black (2.5 parts by weight), a binder polyvinylidene fluoride (1.9 parts by weight), and a dispersant polyvinyl pyrrolidone (0.1 parts by weight) were mixed to obtain a positive electrode mixture, and the positive electrode mixture was dispersed in N-methyl pyrrolidone to obtain a positive electrode mixture slurry. The positive electrode mixture slurry was then coated onto a positive electrode current collector made of aluminum foil, dried, and molded by pressing to form a positive electrode sheet.

Preparation of a negative electrode sheet: A mixture (95.85 parts by weight) of a negative electrode active material, silicon oxide, and graphite powder, in which the weight ratio of silicon oxide to graphite is 9:1, conductive carbon black (1 part by weight), binders carboxymethyl cellulose and styrene-butadiene latex (3.15 parts by weight), and an appropriate amount of water were stirred to prepare a negative electrode mixture slurry. The negative electrode mixture slurry was then uniformly coated onto a negative electrode current collector made of copper foil, dried, and molded by pressing to form a negative electrode sheet.

Formulation of an electrolyte: Ethylene carbonate (20 parts by weight), dimethyl carbonate (62 parts by weight), and lithium hexafluorophosphate (18 parts by weight) were mixed to prepare a basic electrolyte.

Battery assembly: CR2016 button battery is assembled in a dry laboratory. The positive electrode sheet prepared in the described step as a positive electrode, the negative electrode sheet prepared in the described step as a negative electrode, the electrolyte prepared in the described step, a separator, and a battery housing of a button battery are assembled. After the battery is assembled, the battery is allowed to stand for 12 h and aged to obtain an NCA button battery.

### Examples 1-13

Lithium-ion batteries of Examples 1-13 were prepared using the same procedure as in the Comparative Example above. The difference lies in that, in Examples 1 to 13, ethylene carbonate (20 parts by weight), dimethyl carbonate (62 parts by weight), and lithium hexafluorophosphate (18 parts by weight) were mixed in the formulation step of the electrolyte to prepare a basic electrolyte, and additives listed in the following Table 1 were respectively added to 100 parts by weight of the prepared basic electrolyte, The amount of the additives added in 100 parts by weight of the basic electrolyte is also shown in Table 1.

TABLE 1

| | | Amount of |
|---|---|---|
| | | additive (parts |
| | Additive compounds | by weight) |
| Example 1 | compound of Formula (2) | 0.5 |
| Example 2 | compound of Formula (2) | 1.0 |
| Example 3 | compound of Formula (2) | 2.0 |
| Example 4 | compound of Formula (3) | 0.5 |
| Example 5 | compound of Formula (3) | 1.0 |
| Example 6 | compound of Formula (3) | 2.0 |
| Example 7 | compound of Formula (2) | 0.1 |
| Example 8 | compound of Formula (2) | 5.0 |
| Example 9 | compound of Formula (3) | 0.1 |
| Example 10 | compound of Formula (3) | 5.0 |
| Example 11 | compound of Formula (4) | 1.0 |
| Example 12 | compound of Formula (5) | 1.0 |
| Example 13 | compound of Formula (6) | 1.0 |

### Test of Battery Performance

The batteries prepared in the Comparative Example and Examples 1 to 13 were subjected to charge-discharge test and impedance test at 2.5-4.25 V at room temperature.

The test was conducted first 1 cycle at 25° C. with 0.1 C and then 100 cycles at 60° C. with 5C. The capacities of the batteries before and after the cycle test were measured at 60° C. to determine the capacity maintenance rate of the batteries at 60° C., respectively, the volumes of the batteries before and after the cycle test were measured to determine the volume growth rate of the batteries, respectively, and the impedance values of the batteries after the cycle test were measured.

For the batteries prepared in the Comparative Example and Examples 1-13, the results obtained in the tests above are shown in Table 2.

TABLE 2

| | | | Volume |
|---|---|---|---|
| | Cycle retention | Impedance after | growth rate of |
| | rate at 60° C. (%) | cycling (Ω) | battery (%) |
| Comparative | 70.34 | 23.52 | 25.65 |
| Examples | | | |
| Example 1 | 71.25 | 25.64 | 22.79 |
| Example 2 | 73.56 | 27.23 | 21.61 |
| Example 3 | 71.89 | 32.57 | 20.89 |
| Example 4 | 71.68 | 22.41 | 24.04 |
| Example 5 | 74.76 | 21.38 | 22.87 |
| Example 6 | 72.57 | 21.85 | 22.13 |
| Example 7 | 70.61 | 23.69 | 25.35 |
| Example 8 | 69.23 | 37.92 | 19.86 |
| Example 9 | 70.72 | 23.04 | 25.58 |
| Example 10 | 69.46 | 25.73 | 20.94 |
| Example 11 | 72.61 | 26.27 | 22.43 |
| Example 12 | 71.59 | 27.60 | 23.17 |
| Example 13 | 72.78 | 25.67 | 23.45 |

It can be determined from Table 2 that, the lithium-ion batteries (Examples 1-13) prepared by using the electrolytes with the additive of the present application show improvement of at least one performance of the cycle retention rate, the impedance after cycling, and the battery volume growth rate at 60° C., compared with the lithium-ion battery (Comparative Example) prepared by using the electrolyte without the additive of the present application.

In addition, it can be determined from the respective comparison of the results of Examples 1-3 and 7-8, and Examples 4-6 and 9-10 that when the amount of the additive in 100 parts by weight of the basic electrolyte is within the range of 0.5 to 2 parts by weight, the respective lithium-ion batteries particularly exhibit better electrochemical performance in terms of cycle retention rate at 60° C. In particular, Examples 4-6 exhibit better performance than the Comparative Example in terms of the cycle retention rate, the impedance after cycling, and the battery volume growth rate at 60° C. Of these, although not wishing to be bound by theory, it is believed that the increase in the impedance after cycling shown in Examples 1-3 and 11-13 relative to the Comparative Example is due to the increased resistance due to film formation of the additives on the electrode surface, and the decrease in the impedance after cycling shown in Examples 4-6 relative to the Comparative Example demonstrates that the film formed by the thienyl groups in the additive has good conductivity, and therefore can suppress an increase in the impedance after cycling.

In addition, each of Example 11-13 exhibits performance improvement in the cycle retention rate and the cell volume growth rate at 60° C. compared with the Comparative Example.

The results of Examples 7 and 8 show that, when the content of the additive is lower than the described range of the present application, although the impedance after cycling is improved compared with those of Examples 1-3, the cycle retention rate and the cell volume growth rate at 60° C. are both deteriorated compared with those of Examples 1-3. When the content of the additive is higher than the described range of the present application, although the battery volume growth rate is improved compared with those in Examples 1-3, the cycle retention rate at 60° C. and the impedance after cycling are deteriorated compared with those in Examples 1-3.

The results in Examples 9-10 show that, when the content of the additive is lower than the described range of the present application, the cycle retention rate, the impedance after cycling, and the battery volume growth rate at 60° C. are all deteriorated as compared with those in Examples 4-6. When the content of the additive is higher than the described range of the present application, although the battery volume growth rate is improved compared with those in Examples 4-6, the cycle retention rate and the impedance after cycling at 60° C. are deteriorated compared with those in Examples 4-6.

In conclusion, by adding the additive of the present application to an electrolyte of a lithium-ion battery, particularly a lithium-ion battery using a high-nickel positive electrode active material, and further adding the additive of the present application in an amount described herein, the high-temperature cycle performance of the lithium-ion battery can be effectively improved, and oxygen evolution is suppressed, and gas production is reduced.

It should be understood the various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An additive for an electrolyte of a lithium-ion battery, the additive comprising a structure of a following formula (1): 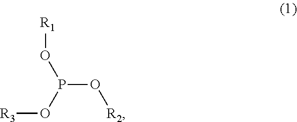
wherein R₁, R₂, and R₃ are each independently a saturated or unsaturated hydrocarbon group, a cyano group, an amide group, a pyridyl group, a thienyl group, or an aryl group having 5-15 carbon atoms and being substituted by at least one fluorine atom.

2. The additive for an electrolyte of a lithium-ion battery according to claim 1, wherein R₁, R₂, and R₃ are each independently an alkenyl group, an alkynyl group, a cyano group, a pyridyl group, or a thienyl group having 5-15 carbon atoms and being substituted by at least one fluorine atom.

3. The additive for an electrolyte of a lithium-ion battery according to claim 2, wherein the additive is at least one of a compound as follows:

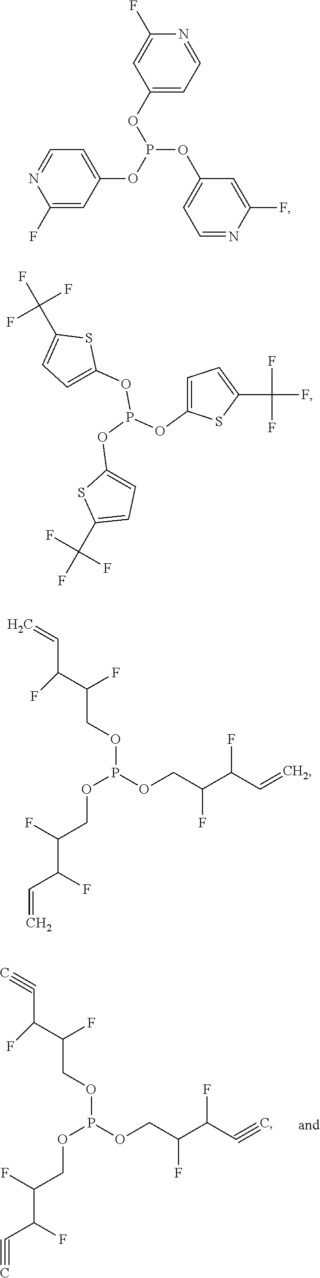

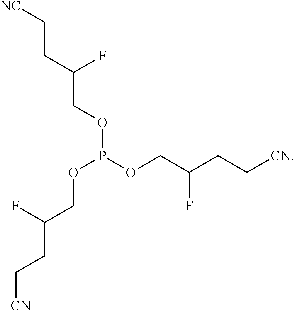 [SMILES: N#CCCC(F)COP(OCC(F)CCC#N)OCC(F)CCC#N]

4. An electrolyte for a lithium-ion battery, wherein the electrolyte comprises the additive for an electrolyte of a lithium-ion battery according to claim 1, an organic solvent, and a lithium salt.

5. The electrolyte for a lithium-ion battery according to claim 4, wherein the amount of the additive is in a range of 0.5 parts by weight to 2 parts by weight based on 100 parts by weight of the organic solvent and the lithium salt.

6. The electrolyte for a lithium-ion battery according to claim 4, wherein the organic solvent comprises a cyclic carbonate ester, a linear carbonate ester, or any combination thereof.

7. The electrolyte for a lithium-ion battery according to claim 6, wherein the organic solvent is selected from the group consisting of propylene carbonate, butylene carbonate, fluoroethylene carbonate, ethylene carbonate, diethyl carbonate, dipropyl carbonate, methylethyl carbonate, dimethyl carbonate, and combinations thereof.

8. The electrolyte for a lithium-ion battery according to claim 4, wherein the lithium salt is selected from the group consisting of LiCl, LiBr, LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, Li₂SiF₆, and combinations thereof.

9. A lithium-ion secondary battery, comprising:
a positive electrode sheet,
a negative electrode sheet,
a separator,
the electrolyte for a lithium-ion battery according to claim 4.

10. The lithium-ion secondary battery according to claim 9, wherein the positive electrode active material of the positive electrode sheet is a high-nickel positive electrode material.
